(19) United States
(12) Patent Application Publication
(10) Pub. No.: US 2026/0067076 A1
(43) Pub. Date: Mar. 5, 2026

(54) METHOD AND SYSTEM FOR GENERATING A UNIQUE IDENTIFIER FOR AN ENTITY

(71) Applicants: Prem Sehgal, Haryana (IN); Harpreet Sachdeva, Haryana (IN)

(72) Inventors: Prem Sehgal, Haryana (IN); Harpreet Sachdeva, Haryana (IN)

(21) Appl. No.: 19/008,711

(22) Filed: Jan. 3, 2025

Related U.S. Application Data
(63) Continuation-in-part of application No. 18/824,242, filed on Sep. 4, 2024.

(51) Int. Cl. H04L 9/08; H04L 9/06

(52) U.S. Cl. CPC H04L 9/0866; H04L 9/0643; H04L 9/0825

(57) ABSTRACT

A system and method for generating a unique user identifier and assigning it to an entity is disclosed. The system comprises a web server configured to request a unique identifier and an identifier service operably connected to the web server. The identifier service includes a random number generator that generates a random number array, a central counter that maintains a counter value, and a processor that combines the random number array with the counter value to form a unique value. The unique value is then converted into a 16-digit string by a converter. The identifier service transmits the 16-digit unique identifier back to the web server, which assigns the identifier to the entity. This system ensures efficient and secure generation of unique identifiers.

### CROSS-REFERENCE TO RELATED APPLICATIONS

This application is a continuation in part application of U.S. patent application Ser. No. 18/824,242 for “A Method and System for Secured and Private Onboarding of a User in a Social Media Application”, filed on Sep. 4, 2024 which is incorporated herein by reference.

### FIELD OF TECHNOLOGY

Certain embodiments of the disclosure relate to the field of generating random number. Specifically, it pertains to methods and systems for generating a unique identifier for an entity. More specifically, certain embodiments of the disclosure provide a method for generating a unique identifier to assign the generated identifier to an entity.

### BACKGROUND

The present disclosure relates to the field of identification systems, more particularly to the generation of unique identifiers for assigning to entities within a web-based environment. In various online systems, uniquely identifying users or entities is crucial for tracking, managing, and authenticating interactions. Such unique identifiers enable secure and efficient handling of transactions, user profiles, and other digital activities across a wide range of applications, from e-commerce platforms to secure databases.

However, in conventional systems, there are several challenges associated with generating and assigning unique identifiers. Commonly used approaches, such as sequential numbering or time-based generation, often face issues with scalability, predictability, and potential duplication when deployed on a large scale. Moreover, security concerns arise when predictable identifiers are generated, as they can be more easily exploited by malicious actors. These limitations underscore the need for more robust and reliable mechanisms that ensure uniqueness across different entities while maintaining efficiency and security.

In light of these issues, there is a growing demand for systems that can dynamically generate truly unique identifiers, incorporating randomness and centralized management to avoid duplication. Existing techniques, while attempting to address scalability or security, often lack the ability to simultaneously manage both, leading to bottlenecks in performance or increased risk of identifier collisions. Thus, there is a critical need for a system capable of overcoming these shortcomings, providing reliable, scalable, and secure identifier generation for modern web environments.

### SUMMARY

A system and method for generating a unique identifier, substantially as shown in and/or described in connection with at least one of the figures, as set forth more completely in the claims.

In a first aspect, the disclosure relates to a method for generating a unique identifier. the method comprises
Receiving a request from a web server;
Generating, by an identifier service, a random number array;
Maintaining, by the identifier service, a central counter;
Combining, by the identifier service, the random number array and the counter to form a unique value;
Converting, by the identifier service, the unique value to a 16-digit string;
Returning, by the identifier service, the 16-digit unique identifier to the web server;
Assigning, by the web server, the unique identifier to the entity.

Optionally, assigning the unique identifier to the entity comprises:
Creating, by the web server, a circle object and a circle of influence object associated with the unique identifier, wherein the circle and the circle of influence object comprises one or more attributes and functions of the entity;
Creating, by the web server, a hash address of the circle object and circle of influence object, wherein the circle hash address is based on a circle identifier and the user identifier, and the circle of influence hash address is based on the circle hash address and circle of influence of identifier;
Encrypting, by the web server, the hash address of the circle object and COI object using a generated public key;
Transmitting, by the web server, the unique identifier, the encrypted hash addresses, and the private key back to an application of the entity.

Optionally, generating a random number array comprises
Generating an array of random bytes with a pre-defined length, wherein the pre-defined length is 16 bytes; and
Calling a function to fill the random bytes array with random values.

Optionally, maintaining a central counter comprises
Accessing the counter to ensure thread safety during a counter increment operation,
wherein the counter is a shared atomic long variable;
Ensuring the counter is maintained by the identifier service.

Optionally, combining the random number array and the counter to form a unique value comprises
Performing bitwise operations to concatenate the random bytes and the counter to form a single 56-bit value;
Ensuring each byte is bitwise ANDed with 0xff to convert it from a signed byte to an unsigned byte;
Left-shifting the 56-bit combined value by 8 bits and appending the lower 8 bits of the counter to the shifted value using a bitwise OR operation.

Optionally, converting the unique value to a 16-digit string comprises
Converting the 64-bit unique value into a 16-digit string with leading zeroes using a StringFormat method;

Applying a modulo operation with 10000000000000000L to ensure the unique value remains within the 16-digit range.

Optionally, returning the 16-digit unique identifier comprises
Calling a SecureAPI method to return the unique identifier generated;
Passing the unique identifier to the web server for further processing.

Optionally, the function is configured to use the java. util. Random class for generating random numbers.

Optionally, the atomic long variable is updated within a synchronized block to prevent race conditions.

Optionally, the bitwise operations used to combine the random bytes and the counter involve
Left-shifting each byte of the random bytes array by a multiple of 8 bits;
Combining the shifted bytes using a bitwise OR operation to form the 56-bit value.

Optionally, the StringFormat method is used to format the unique value into a 16-digit string with leading zeroes.

Optionally, the SecureAPI method ensures the secure transmission of the unique identifier for assigning the identifier to the entity.

In another aspect the present disclosure provides a system for generating a unique identifier. The system comprises a processor configured to execute non-transitory machine-readable instructions. The system comprises
a web server configured to send a request for generating a unique user identifier;
an identifier service configured to:
   generate a random number array;
   maintain a count value;
   combine the random number array and the central counter to form a unique value;
   convert the unique value into a 16-digit string;
   return the 16-digit unique identifier to the web server; and
wherein the web server is further configured to assign the unique identifier to the entity.

Optionally, web server is further configured to assign the unique identifier to the entity comprises:
create a circle object and a circle of influence object associated with the unique identifier, wherein the circle and the circle of influence object comprises one or more attributes and functions of the entity;
create a hash address of the circle object and circle of influence object, wherein the circle hash address is based on a circle identifier and the user identifier, and the circle of influence hash address is based on the circle hash address and circle of influence of identifier;
encrypt the hash address of the circle object and COI object using a generated public key;
transmit the unique identifier, the encrypted hash addresses, and the private key back to an application of the entity.

Optionally, the identifier services is configured to
generate an array of random bytes with a pre-defined length, wherein the pre-defined length is 16 bytes; and
call a function to fill the random bytes array with random values.

Optionally, the identifier services is configured to
access the counter to ensure thread safety during a counter increment operation, wherein the counter is a shared atomic long variable;
ensure the counter is maintained by the identifier service.

Optionally, the identifier services is configured to
perform bitwise operations to concatenate the random bytes and the counter to form a single 56-bit value;
ensure each byte is bitwise ANDed with 0xff to convert it from a signed byte to an unsigned byte; and
left-shift the 56-bit combined value by 8 bits and appending the lower 8 bits of the counter to the shifted value using a bitwise OR operation.

Optionally, the identifier services is configured to
convert the 64-bit unique value into a 16-digit string with leading zeroes using a StringFormat method;
apply a modulo operation with 10000000000000000L to ensure the unique value remains within the 16-digit range.

Optionally, the identifier services is configured to
Call a SecureAPI method to return the unique identifier generated;
Pass the unique identifier to the web server for further processing.

Optionally, the function is configured to use the java. util. Random class for generating random numbers.

Optionally, the atomic long variable is updated within a synchronized block to prevent race conditions.

Optionally, the bitwise operations comprise
Left-shifting each byte of the random bytes array by a multiple of 8 bits; and
Combining the shifted bytes using a bitwise OR operation to form the 56-bit value.

Optionally, the StringFormat method is used to format the unique value into a 16-digit string with leading zeroes.

These and other advantages, aspects and novel features of the present disclosure, as well as details of an illustrated embodiment thereof, will be more fully understood from the following description and drawings.

### BRIEF DESCRIPTION OF SEVERAL VIEWS OF THE DRAWINGS

FIG. 1 is a block diagram that illustrates an exemplary system 100 for generating a unique identifier, in accordance with an exemplary embodiment of the disclosure.

FIG. 2 is a flow chart that illustrates an exemplary method 200 for generating a unique identifier, in accordance with an exemplary embodiment of the disclosure.

FIG. 3 is a block diagram that illustrates an exemplary structure for implementation of the system 100 for generating a unique identifier, in accordance to the exemplary embodiments of the disclosure.

FIG. 4, is a block diagram that illustrates an exemplary structure for circle objects and circle of influence objects, in accordance to the exemplary embodiments of the disclosure.

### DETAILED DESCRIPTION OF THE DISCLOSURE

Certain embodiments of the disclosure relate to a method and system for generating a unique identifier. The principal object of the present invention is to provide a system and method for generating unique identifiers to be assigned to entities, such as users or devices, in various fields of application, including but not limited to social media platforms and defence-related networks. Beneficially, the generated identifiers are completely random, thereby ensuring that they cannot be used to identify or trace the underlying entity. This randomness serves to enhance privacy, security, and anonymity, which are critical in environments where protection of entity identity is of utmost importance.

In the context of social media, the application of the invention enables the generation of unique, non-identifying identifiers that facilitate user interactions, engagements, and activities on the platform while safeguarding personal information. The user and one or more objects associated with the social media platform are assigned the unique identifiers. The random nature of the identifiers ensures that no identifying details of the user can be inferred or traced from the identifier itself, thereby reducing the risk of data breaches, exploitation, or privacy violations.

Similarly, in defence-related networks, the application of the invention provides for the generation of unique, random identifiers to ensure secure and anonymous communication between entities, such as soldiers, devices, or operatives, particularly in scenarios involving sensitive or covert operations. Beneficially, the system ensures that no direct or indirect linkage between the identifier and the entity's true identity can be established, thereby enhancing operational security and reducing vulnerability to external threats.

By implementing a system that guarantees both uniqueness and randomness in the generation of identifiers, the present invention addresses the critical need for secure, anonymous, and privacy-preserving entity management across a broad range of application areas, where the protection of entity identity is a fundamental requirement.

In an embodiment, unique identifiers are distinct alphanumeric or numerical sequences assigned to individual entities for the purpose of uniquely identifying and distinguishing them within a given system, database, or network. These identifiers are integral for ensuring the accurate management, tracking, and reference of entities, as they guarantee that each entity is differentiated from others within the same environment. The assignment of an anonymous unique identifier to an entity is fundamental in ensuring that operations, transactions, and interactions associated with the entity are accurately executed and traceable.

A unique identifier is characterized by its singularity, ensuring that no two entities within the designated system share the same identifier, thereby eliminating the possibility of duplication or confusion. Additionally, unique identifiers are typically designed to be persistent and non-transferable, such that the identifier remains associated with the entity to which it was originally assigned, notwithstanding any changes to the entity's other attributes. The form of a unique identifier may vary depending on the system or context in which it is implemented, and can include numerical codes, alphanumeric strings, or more complex structures such as Universally Unique Identifiers (UUIDs).

The application of unique identifiers is widespread across various domains, including, but not limited to, networking, software development, e-commerce, and regulatory compliance. Examples include Social Security Numbers (SSNs) used to uniquely identify individuals within the social welfare system, Internet Protocol (IP) addresses assigned to devices on a network, and ISBNs (International Standard Book Numbers) that distinguish published works. The effective use of unique identifiers is critical for ensuring system integrity, data consistency, and the accurate representation of entities within technological and administrative frameworks.

Typically, an application programming interface (API) call is initiated by a web server, which serves as a requesting entity. This API call is directed towards an identifier service for the purpose of generating a unique identifier. Upon receipt of the request, the identifier service is instantiated and becomes operative to perform the requisite actions to generate the unique identifier. This process may include the execution of one or more operations such as generating a random number array, maintaining or updating a central counter, and combining these elements to produce a unique value. Once the unique identifier is generated, it is formatted or converted into the required structure, such as a 16-digit string or other specified format.

Upon successful generation of the unique identifier, the identifier service transmits the identifier back to the web server in response to the original API call. The web server, acting as the receiving entity, processes the returned identifier and assigns it to the relevant entity, such as a user, device, or object, in accordance with its structural requirements. This assignment ensures that the entity is uniquely identified within the system, allowing for subsequent tracking, transactions, or interactions. Beneficially, the seamless coordination between the web server and the identifier service, facilitated by the API call, is essential to the efficient generation and assignment of unique identifiers within such systems.

In an embodiment, an entity refers to any individual, object, device, or other identifiable subject within a system that requires unique differentiation from other such subjects. Entities may include, but are not limited to, users of a software platform, hardware components, transactions, data sets, or digital assets. The assignment of a unique identifier to an entity enables the system to unequivocally distinguish that entity from all others, thereby facilitating the reliable management, operation, and interaction of the entity within the system's framework.

Beneficially, assignment of unique identifier to an entity lies in the precision and integrity it brings to the system. By ensuring that each entity is assigned a unique identifier, the system can reliably manage large volumes of entities while maintaining consistent and accurate records. Additionally, the seamless communication between the web server and the identifier service—facilitated by the API call—enables the system to scale efficiently, generating and assigning identifiers in real time without unnecessary delays or errors. This integration of identifier generation and assignment enhances the system's capacity for secure and efficient data handling, particularly in environments that require high levels of transaction processing or entity management, such as e-commerce platforms, financial services, or network infrastructures.

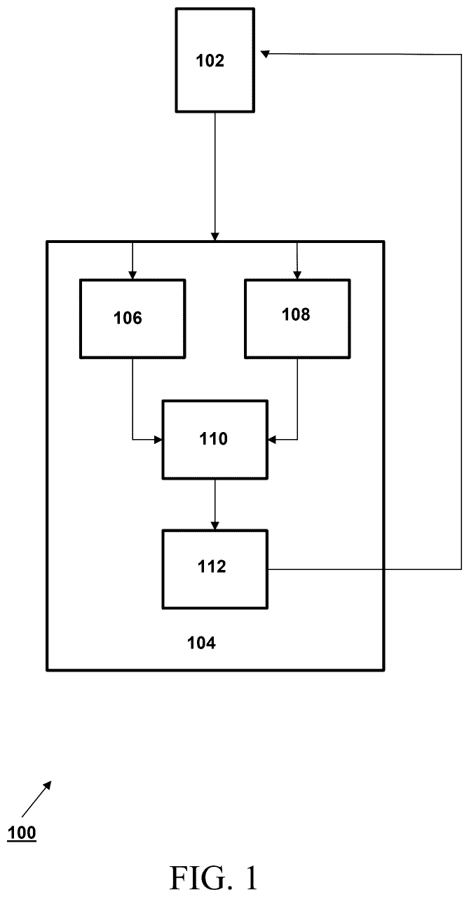

FIG. 1 is a block diagram that illustrates an exemplary system 100 for generating a unique identifier, in accordance with an exemplary embodiment of the disclosure. Referring to FIG. 1, a system 100 comprises of a web server 102 and an identifier service 104 communicable coupled to generate and assign a unique identifier to an entity.

In an embodiment, the web server 102 comprises of request handling module, API communication module, assignment module, data integrity and security module, and logging and audit module. The web server 102 facilitates communication between a client-side and the identifier service 104. In an embodiment, the web server 102, as used herein, refers to a computing system or a software component designed to handle requests from clients, transmit them to identifier service 104, and return responses to the requesting clients. Beneficially, the web server 102 is responsible for initiating the process of identifier generation and ensuring the successful assignment of the identifier to the corresponding entity. In embodiment, the request handling module of the web server 102 serves as the interface between client-side entities (e.g., users, devices, or systems) and the identifier service 104. The request handling module is configured to receive requests from the client-side through mechanisms such as an API call or HTTP request. Upon receiving the request, the request handling module processes the incoming data, validates the request parameters, and forwards the request to the appropriate service, including the identifier service 104, for further processing. Beneficially, this ensures that only valid and properly formatted requests are forwarded. In an embodiment, the API communication module within the web server 102 is responsible for facilitating interaction with the identifier service 104. This component initiates API calls to the identifier service 104, transmitting the necessary data or parameters to trigger the generation of a unique identifier. Upon the identifier service 104 generating the unique identifier, the API communication module is further tasked with receiving the generated identifier and ensuring its secure transmission back to the appropriate internal modules for subsequent assignment to the entity. In an embodiment, the assignment module is responsible for assigning the unique identifier, as received from the identifier service 104, to the relevant entity within the system 100. Beneficially, this assignment module ensures that the identifier is correctly associated with the specific entity, whether it is a user, a device, or any other object requiring identification. Optionally, the web server 102 is configured to create a circle object and a circle of influence object associated with the unique identifier, wherein the circle and the circle of influence object comprises one or more attributes and functions of the entity. Further, optionally, the web server 102 is configured to create a hash address of the circle object and circle of influence object, wherein the circle hash address is based on a circle identifier and the user identifier, and the circle of influence hash address is based on the circle hash address and circle of influence of identifier. Beneficially, the assignment module assigns one or more unique identifiers to user, the circle object or the circle of influence object. Furthermore, the web server 102 is configured to generate a public key and private key. Furthermore, the web server 102 is configured to encrypt the hash address of the circle object and circle of influence object using the generated public key. Furthermore, the web server 102 is configured to transmit the unique identifier, the encrypted hash addresses, and the private key back to an application of the entity. Optionally, the assignment module also updates the system's internal records or databases to reflect the association between the entity and the unique identifier, ensuring that future operations, transactions, or interactions involving the entity can be accurately referenced using the assigned identifier. Given the importance of maintaining the security and integrity of identifiers within the system, the web server 102 optionally include a data integrity and security module. Beneficially, this component ensures that the transmission of identifier-related data between the web server 102, identifier service 104, and client-side entities is secure and protected from unauthorized access or manipulation. Additionally, the module verifies the integrity of the unique identifier once it is generated and received, ensuring that no corruption or tampering has occurred during the transmission process. In an embodiment, to ensure traceability and accountability, the web server 102 may also include a logging and audit module. This component records all relevant transactions, including requests for identifier generation, communications with the identifier service, and the assignment of unique identifiers to entities. These records are maintained for auditing purposes, enabling the system to trace the history of any identifier or entity interaction, which is particularly critical for compliance with regulatory requirements or troubleshooting operational issues. Beneficially, the web server 102, through these components, enables the efficient and secure generation and assignment of unique identifiers to entities within the system 100, ensuring that the entire process is seamlessly coordinated and that subsequent interactions with the entity are reliable, consistent, and traceable.

The identifier service 104 is configured to perform the function of generating a random number array 106, which serves as a critical component in producing unique identifiers. Specifically, the identifier service is designed to generate an array of random bytes, wherein the length of the array is pre-defined to be 16 bytes. Beneficially, this pre-defined length is established to ensure that the generated identifiers conform to a consistent and reliable format, which is essential for their subsequent use in assigning to entities. The identifier service 104 utilizes a specific function to populate the random byte array with randomly generated values. This function, which is instantiated by calling a method or class designed for random number generation, ensures that each byte in the array is filled with a random value. For example, in the context of the Java programming language, the service may call an instance of the java. util. Random class, a well-established tool for generating random numbers. Through this class, the function generates and assigns random values to each position in the array, resulting in an array of 16 random bytes. For instance, the array may appear as [68, −97, −39, 98, 84, −86, −2], representing a series of randomly generated values assigned to each byte. In an embodiment, the random ( ) function, which is an instance of the java.util.Random class, is invoked to execute this process of random number generation. This function is a standard utility in programming, specifically configured to produce random numbers that can be utilized to populate arrays, ensuring that the resulting byte sequence exhibits a high degree of randomness. The process of calling this function and filling the byte array at 106 is essential to the generation of unique identifiers, as it introduces a non-deterministic element, thereby reducing the likelihood of duplication or predictability in the identifiers created. Beneficially, the technical design and execution of this process 106 is critical to ensuring that the unique identifiers generated by the identifier service are random, secure, and unrepeatable, making them suitable for applications requiring high levels of reliability and security, such as in web-based systems, cryptographic applications, or large-scale databases. Furthermore beneficially, the use of a pre-defined length (16 bytes) ensures that the identifier conforms to expected specifications, facilitating its consistent use within the system 100.

The identifier service 104, as described, is further configured to maintain a count value, specifically to ensure that unique identifiers are generated without duplication. The count value, referred to as a counter 108, is used in conjunction with the random number array to ensure the generation of a truly unique identifier. This counter 108 is implemented as a shared atomic long variable, a data type that allows the identifier service 104 to safely and efficiently manage the counter across multiple threads within a concurrent processing environment. Beneficially, to ensure the integrity and accuracy of the counter during operations that involve incrementing its value, the identifier service is configured to access the counter in a manner that ensures thread safety. This is achieved by utilizing the atomic long variable, which allows operations on the counter 108 to be performed atomically—that is, in an indivisible manner—thereby preventing intermediate states that could lead to inconsistencies. Thread safety is particularly critical in multi-threaded environments, where multiple threads may attempt to increment or access the counter simultaneously. Without proper safeguards, this could lead to race conditions, wherein two or more threads try to modify the counter concurrently, resulting in unpredictable outcomes or data corruption. Beneficially, to prevent race conditions and ensure that only one thread can update the counter at any given time, the identifier service 104 accesses and modifies the atomic long variable within a synchronized block. The synchronized block ensures that the section of code responsible for updating the counter is executed by only one thread at a time, thus preventing simultaneous access or modification by other threads. Beneficially, this locking mechanism guarantees that each counter increment is executed in an orderly manner, avoiding conflicts or incorrect values being assigned. By maintaining the counter as an atomic long variable and utilizing synchronized blocks to manage its updates, the identifier service 104 ensures that the counter 108 remains consistent, reliable, and safe from concurrency issues. This approach safeguards the uniqueness and integrity of the generated identifiers by preventing overlapping increments or errors that could arise from simultaneous operations. In essence, the service 104 ensures that the counter 108 is incremented in a controlled, thread-safe manner, further contributing to the overall robustness of the identifier generation process. For example, the counter value 108 may be set to −623032423983775989, and its binary representation may be −01110001010101000011010101000011010101010101001. This counter 108 is incremented each time a new identifier is generated, ensuring that each identifier is unique, even in cases where they are generated within extremely short intervals. The use of both an atomic long variable and a synchronized block ensures that the system 100 operates efficiently and securely, preventing errors or duplication during the identifier generation process.

The identifier service 104, in the context of generating a unique value 110, is configured to combine the random number array 106 and the counter 108 using a series of bitwise operations. The purpose of these operations is to concatenate the random bytes generated in the previous step with the counter to form a unique, combined value, which in this case, is a 56-bit value. The concatenation of the random bytes 106 and the counter 108 through these bitwise operations ensures that each unique identifier is both random and traceable to the system's internal counter, adding a layer of uniqueness even when identifiers are generated in rapid succession. The process for generating the unique value 110 begins by performing bitwise AND operations on each byte of the random number array 106. Specifically, each byte is ANDed with 0xff, which converts the signed byte into an unsigned byte. This ensures that each byte can be correctly represented as an unsigned value, allowing for proper bitwise manipulation in subsequent steps. The 0xff mask effectively isolates the lower 8 bits of each byte, preserving its unsigned value, as bitwise operations require unsigned byte values to function as intended. Following this conversion, the bytes in the random array 106 are left-shifted by a multiple of 8 bits to create segments of a 56-bit value. Each byte in the random array 106 is shifted by a different amount, corresponding to its position in the array. For example, the first byte is shifted left by 48 bits, the second by 40 bits, the third by 32 bits, and so on. This operation aligns each byte at its designated position within the final 56-bit value. After shifting each byte, the individual shifted byte values are then combined using a bitwise OR operation. The bitwise OR operation merges the shifted values, resulting in a single 56-bit value that contains all the information from the original random bytes array. By performing this operation sequentially for each byte, the random number array 106 is effectively concatenated into a single continuous value. Once the random bytes have been combined into a 56-bit value, the counter 108 is also introduced into the combination. The 56-bit combined value is left-shifted by 8 bits, and the lower 8 bits of the counter are then appended to this value using another bitwise OR operation. This ensures that the counter 108 is incorporated into the final value without disrupting the structure of the random byte data, allowing the system to maintain a balance between randomness and sequential uniqueness. For instance, if the random number array consists of the following bytes: [68, −97, −39, 98, 84, −86, −2]. Each byte undergoes the bitwise AND operation to convert it into an unsigned byte and is then shifted accordingly: part1=((long) randomBytes[0] & 0xff)<<48; part2=((long) randomBytes[1] & 0xff)<<40; part3=((long) randomBytes[2] & 0xff)<<32; part4=((long) randomBytes[3] & 0xff)<<24; part5=((long) randomBytes[4] & 0xff)<<16; part6=((long) randomBytes[5] & 0xff)<<8; part7=((long) randomBytes[6] & 0xff). The resulting values are then combined: combinedValue1=part1|part2|part3|part4|part5|part6|part7. This results in the final unique value: combinedValue1=19316054422760190. Beneficially, this approach ensures that the random bytes 106 and counter 108 are effectively combined to produce a unique value that is random, traceable, and scalable, while maintaining the integrity of the random and sequential components within a 56-bit structure. This unique combination 110 provides an optimal balance between randomness (from the random bytes array 106) and sequential uniqueness (from the counter 108), making it suitable for a wide range of applications where both aspects are critical.

The identifier service 104 is further configured to convert the 64-bit unique value generated in the previous step into a 16-digit string 112 using specific formatting and mathematical operations, ensuring that the resulting string conforms to a pre-defined format and range. The conversion process involves two key operations: (1) applying a modulo operation to restrict the unique value to the 16-digit range, and (2) utilizing a StringFormat method to convert the processed value into a string representation, complete with leading zeroes if necessary, to meet the required 16-digit format. The modulo operation is performed by applying the modulus 10000000000000000L to the unique value. This operation ensures that the 64-bit unique value remains within the allowable 16-digit range, effectively constraining it to a maximum value of 9999999999999999 (10\hat{ }16−1). By extracting the remainder when the unique value is divided by 10000000000000000L, the modulo operation guarantees that the resulting value fits within the 16-digit requirement. This step ensures that the value remains manageable and compatible with the system's identifier length constraints, as specified by the pre-defined ID_LENGTH parameter. For instance, if the unique value 110 generated is 4944909932226608651, the modulo operation would calculate the remainder when divided by 10000000000000000L, producing the result 4909932226608651. This result represents the last 16 digits of the unique value, ensuring that it falls within the necessary range. After the modulo operation, the resulting value undergoes further processing to ensure it is represented as a positive number. The Math.abs( ) function is applied to take the absolute value of the result, thus eliminating any potential negative signs that may arise during the previous calculation. This step ensures that the unique identifier remains a positive number, which is critical for systems requiring positive identifiers. Once the value has been appropriately constrained to the 16-digit range and converted to a positive value, the final step involves formatting the value as a 16-digit string 112. This is achieved using the String.format( ) method, which formats the value into a string representation, with leading zeroes if necessary, to ensure the string is exactly 16 digits long. The format specifier “% 016d” ensures that the number is padded with leading zeroes if it is less than 16 digits in length, maintaining the required format for the unique identifier. For example, if the value after the modulo operation is 4909932226608651, the String. format method will convert this value into the string “4909932226608651”, ensuring that it is formatted as a 16-digit string. In cases where the result has fewer than 16 digits, the leading zeroes would be added automatically to meet the format requirement. Thus, the final unique identifier is a 16-digit string 112, representing the combination of random values 106 and the counter 108, formatted and processed to meet the system's constraints. This conversion process ensures both the uniformity of the identifier length and the randomness and uniqueness of the values, enabling efficient and reliable tracking and identification of entities within the system.

The identifier service 104 is further configured to return the 16-digit unique identifier 112 generated through a secure transmission process to the web server 102 for subsequent processing and assignment to an entity. This step involves invoking a SecureAPI method, which is designed to facilitate the secure transmission of the unique identifier, ensuring its integrity and confidentiality during transit. Upon successful generation of the 16-digit unique identifier, the identifier service 104 calls the SecureAPI method, which is responsible for securely returning the identifier 112 to the requesting web server 102. The SecureAPI method ensures that the unique identifier 112 is transmitted over a secure communication channel, typically involving encryption protocols or other security measures, to prevent unauthorized access, interception, or tampering during the transmission process. This safeguard is essential, as the unique identifier 112 represents a sensitive piece of data within the system 100, used to track or identify entities, and any compromise in its security could lead to unauthorized access or misuse. The SecureAPI method guarantees that the unique identifier 112 is securely passed to the web server 102, where it is received for further processing. Upon receiving the unique identifier 112, the web server 102 can proceed to assign it to the relevant entity within the system 100, ensuring that the entity is uniquely identified and can be tracked, monitored, or involved in subsequent transactions or interactions. By employing the SecureAPI method, the system 100 ensures that the transmission of the unique identifier 112 from the identifier service 104 to the web server 102 is conducted in a manner that maintains the confidentiality, integrity, and security of the data 112. This is particularly critical in systems handling sensitive data or operating in environments where security is paramount, such as financial, medical, or personal data management systems. Therefore, the SecureAPI method plays a pivotal role in safeguarding the identifier throughout its lifecycle, from generation to assignment.

In an embodiment, the identifier service 104 is involved in a coordinated interaction with the assignment module of the web server 102, which ensures the unique identifier 112 is effectively utilized for tracking and managing entities within the system 100. Upon receiving the 16-digit unique identifier 112 through the SecureAPI method, the web server 102 initiates a series of processing steps that are integral to assigning the identifier 112 to the relevant entity. The first step in this process typically involves validating the received identifier 112 to ensure that it conforms to the expected format and range. This validation is crucial to confirm that the identifier 112 was correctly generated and transmitted without any corruption or loss of data during the transmission process. Once the identifier 112 has been validated, the web server's 102 assignment module will associate the unique identifier 112 with the specific entity, which may be a user, device, object(s), transaction, or any other relevant object within the system 100. This association typically involves creating or updating a record in a database that maintains the mapping between entities and their corresponding identifiers 112. The assignment module will execute the necessary database operations, such as inserting a new record or updating an existing one, to reflect this association accurately. After the assignment is completed, the web server 102 may perform additional processing steps, such as logging the assignment for audit and compliance purposes. This logging can include details such as the timestamp of the assignment, the identity of the user or system that initiated the request, and any relevant metadata regarding the entity. Such logs are essential for maintaining a transparent and traceable system, which is critical for regulatory compliance and internal accountability. Moreover, once the identifier 112 is assigned, the web server 102 may trigger notifications or update other system 100 components to inform them of the new association. For example, if the entity is a user, the system 100 might send a confirmation message to the user, notifying them of their successful registration or assignment. Additionally, if the entity is involved in transactional processes, the system may initiate workflows that depend on the unique identifier 112, enabling seamless interactions within the application. The efficient collaboration between the identifier service 104 and the web server's 102 assignment module underscores the importance of a secure and reliable identifier generation and assignment process. By ensuring that each identifier is uniquely and correctly assigned to an entity, the system 100 enhances its capability for tracking, monitoring, and managing entities, thereby improving overall operational efficiency and data integrity within the application.

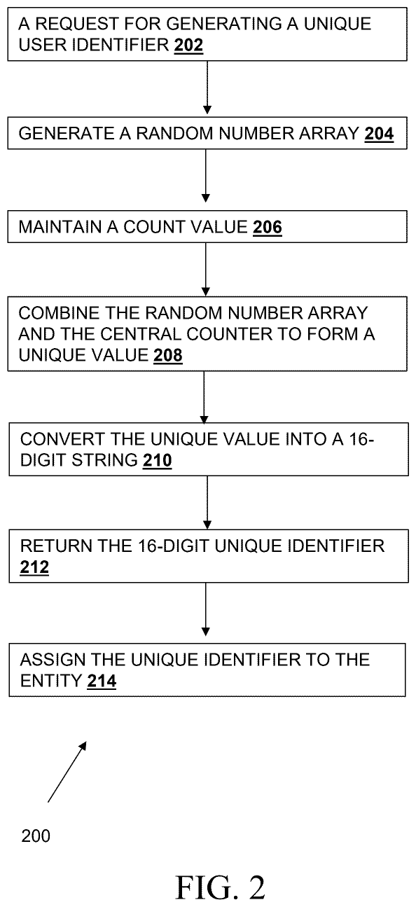

FIG. 2 is a flow chart that illustrates an exemplary method 200 for generation of at least one 16-digit random unique user identifier, in accordance with an exemplary embodiment of the disclosure. Referring to FIG. 2, the identifier service 104 is invoked through an API call from the web server 102 to generate the user identifier.

At step 202, a web server configured to send a request for generating a unique user identifier.

At step 204, the identifier service configured to generate a random number array. Optionally, generating a random number array comprises generating an array of random bytes with a pre-defined length, wherein the pre-defined length is 16 bytes, and calling a function to fill the random bytes array with random values.

At step 206, a central counter is maintained. Optionally, maintaining a central counter comprises accessing the counter to ensure thread safety during a counter increment operation, wherein the counter is a shared atomic long variable, and ensuring the counter is maintained by the identifier service.

At step 208, the random number array and the counter are combined to form a unique value. Optionally, combining the random number array and the counter to form the unique value comprises performing bitwise operations to concatenate the random bytes and the counter to form a single 56-bit value. Optionally combining the random number array and the counter to form the unique value comprises ensuring each byte is bitwise ANDed with 0xff to convert it from a signed byte to an unsigned byte. Optionally left-shifting the 56-bit combined value by 8 bits and appending the lower 8 bits of the counter to the shifted value using a bitwise OR operation. Optionally, the bitwise operations used to combine the random bytes and the counter comprises left-shifting each byte of the random bytes array by a multiple of 8 bits and combining the shifted bytes using a bitwise OR operation to form the 56-bit value.

At step 210, the unique value is converted to a 16-digit string. Optionally, converting the unique value to the 16-digit string comprises converting the 64-bit unique value into a 16-digit string with leading zeroes using a StringFormat method. Optionally, converting the unique value to the 16-digit string comprises applying a modulo operation with 10000000000000000L to ensure the unique value remains within the 16-digit range. Optionally, the StringFormat method is used to format the unique value into a 16-digit string with leading zeroes.

At step 212, the 16-digit unique user identifier is returned to the web server 102. Optionally, returning the 16-digit unique user identifier comprises calling a SecureAPI method to return the unique identifier generated and passing the unique identifier to the web server 102 for further processing. Beneficially, the SecureAPI method ensures the secure transmission of the unique identifier to the web server 102.

At step 214, the web server is further configured to assign the unique identifier to the entity.

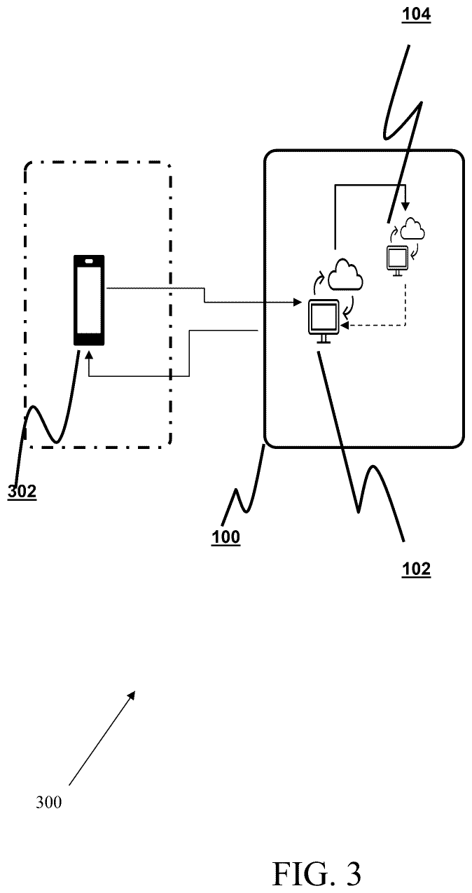

FIG. 3 is a block diagram that illustrates an exemplary structure for implementation of the system 100 for generating a unique identifier, in accordance to the exemplary embodiments of the disclosure. Referring to FIG. 3, a user is associated with a user device 302. The user device 302 comprises a social media application. A user opens the social media app installed on the user device 302 and fills out the registration form, providing necessary details such as username, email, and password. Upon submitting the registration form, the app constructs an HTTPS API request to the web server's 102 registration endpoint. The web server 102 receives the registration request. It validates the input data to ensure that all required fields are present and adhere to any validation rules (e.g., email format, password strength). After successful validation, the web server 102 makes an API call to the identifier service 104 to generate a unique identifier 112 for the user. This call can be made synchronously or asynchronously, depending on the architecture. The identifier service 104 processes the request by generating a unique value using the aforementioned method (random number array and counter) and converts it to a 16-digit string. The service 104 then calls the SecureAPI method to return the generated unique identifier 112 back to the web server 102. Upon receiving the unique identifier 112 from the identifier service 104, the web server 102 updates the user registration record in the database to associate the user with their unique identifier 112. After successfully assigning the identifier 112, the web server 102 generates a response confirming the registration, including the unique identifier 112 and other relevant user information. The user app receives the response and displays a success message to the user, confirming their registration on the social media platform. The unique identifier 112 can be used for subsequent interactions, such as logging in or posting content.

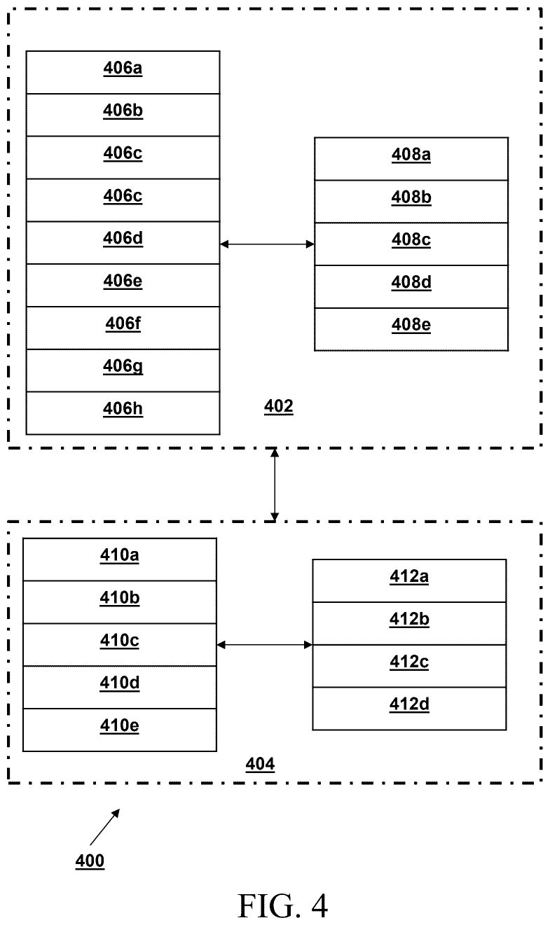

FIG. 4, is a block diagram that illustrates an exemplary structure for circle objects and circle of influence objects, in accordance to the exemplary embodiments of the disclosure. Referring to FIG. 4, the web server 102 is configured to create a circle object 402 and a circle of influence (COI) object 404 associated with the unique identifier. The web server 102 is configured to create a hash address of the circle object and circle of influence object. The circle object 402 comprises of one or more attributes 406a, 406b, 406c, 406d, 406e, 406f, 406g, 406h and functions 408a, 408b, 408c, 408d, 408e to represents a group of users for one or more specific purpose. In an embodiment, the one or more specific purposes comprises of friends, family, colleagues, sports, entertainment. The circle of influence object 404 comprises of one or more attributes 410a, 410b, 410c, 410d, 410e and functions 412a, 412b, 412c, 412d to track and update the circle object 402 based on the user activities in the social media application. The one or more attributes of the circle object 402 comprises of circle identifier 406a, user identifier 406b, circle name 406c, data of circle creation 406d, members 406e, permissions 406f, activity feed 406g, and visibility settings 406h. The one or more functions of the circle object 402 comprises of member management functions 408a, content management functions 408b, notification functions 408c, moderation functions 408d, and analytics functions 408e. The one or more attributes of the circle of influence 404 comprises of circle of influence identifier 410a, influence score 410b, interaction metrics 410c, role definitions 410d, and content visibility 410e. The one or more functions of the circle of influence 404 comprises of influence calculation functions 412a, role management functions 412b, content prioritization functions 412c, and insight functions 412d. The web server 102 is configured to create the circle hash address based on a circle identifier and the user identifier, and the circle of influence hash address based on the circle hash address and circle of influence of identifier. The web server 102 is configured to encrypt the hash address of the circle object and COI object using a generated public key. The web server 102 is configured to transmit the unique identifier, the encrypted hash addresses, and the private key back to the social media application of the entity.

The one or more attributes of the circle object 402 comprises of circle identifier 406a, user identifier 406b, circle name 406c, data of circle creation 406d, members 406e, permissions 406f, activity feed 406g, and visibility settings 406h. Optionally, the circle identifier 406a of the circle object 402 comprises a unique identifier for the circle. Optionally, the user identifier 406b of the circle object 402 comprises unique identifier of the user associated with the user device 102 who created the circle. Optionally, circle name 406c comprises name of the circle. Optionally, data of circle creation 406d comprises date when the circle was created. Optionally, members 406e comprises list of user identifiers who are part of the circle. Optionally, permissions 406f defines actions members can perform (post, comment, invite). Optionally, activity feed 406g comprises list of posts and interactions within the circle. Optionally, visibility settings 406h defines whether the circle is public or private.

The one or more functions of the circle object 402 comprises of member management functions 408a, content management functions 408b, notification functions 408c, moderation functions 408d, and analytics functions 408e. Optionally, the member management function 408a adds, removes, and manage member permissions. Optionally, the content management 408b handle posts, comments, likes within the circle. Optionally, the notification function 408c manages notifications related to circle activities. Optionally, the moderation function 408d ensure content follows community guidelines. Optionally, the analytics function 408e track and provide insights into circle activities.

The one or more attributes of the circle of influence 404 comprises of circle of influence identifier 410a, influence score 410b, interaction metrics 410c, role definitions 410d, and content visibility 410e. Optionally, the circle of influence identifier 410a comprises a unique identifier for the circle of influence. Optionally, the influence score 410b comprises scores assigned to members based on their activity and engagement. In an embodiment, the influence score 410b is based on one or more predefined parameters. In an embodiment, the influence scores 410b are based on the interaction metrics and comprises of one or more algorithms to determine the influence score. Optionally, the interaction metric 410c comprises of data on posts, comments, likes, and other interactions. Optionally, the role definitions 410d comprises of roles and permissions influenced by member's scores. Optionally, the content visibility attribute 410e adjusts content prominence based on influence score 410b.

The one or more functions of the circle of influence 404 comprises of influence calculation functions 412a, role management functions 412b, content prioritization functions 412c, and insight functions 412d. Optionally, the influence calculation function 412a comprises of calculate influence function and update influence function. Further optionally, the calculate influence function determine influence scores for members based on predefined metrics (e.g., number of posts, likes, comments). Further optionally, update influence function continuously update scores based on ongoing activities and interactions. Optionally, the role management functions 412b comprises assigning roles and permissions within the circle based on influence. Optionally, content prioritization function 412c promotes or demotes content visibility based on member influence score 410b. Optionally, insight function 412d offer data and analytics on influence dynamics within the circle.

In an embodiment, the circle object 402 and circle of influence object 404 work together to manage the dynamics within a circle, enhancing user engagement and content visibility. In an embodiment, the web server 106 creates the circle. The circle object 402 is instantiated with initial attributes (e.g., circle identifier, user identifier, circle name). Optionally, the member management function 408a enables the user associated with the user device 102 adds members to the circle. The circle object 402 updates its member 406e list attribute and assigns initial roles/permissions. The circle object instructs the circle of influence object 404 begins tracking these members'(users) activities to calculate their influence scores 410b. The users post content, comment, and like posts within the circle. The circle object 402 manages these interactions through the moderation functions 408d. The circle of influence object 404 tracks these interactions, updating influence scores 410b based on member activity and engagement. Optionally, the server arrangement 104 prioritizes content based on influence scores 410b. Beneficially, the circle of influence object 404 determines the prominence of posts within the activity feed 406g of the circle object. Optionally, the server arrangement manages notification through influence score of members', posts with high score are given higher visibility. The circle object 402 adjusts the activity feed 406g to reflect the prioritized content. In an embodiment, an influential member organizes an event. The circle of influence object 404 recognizes the member's influence and promotes the event within the circle. The circle object 402 ensures the event appears prominently in the feed and sends notifications to members. In an embodiment, circle administrators review analytics to understand engagement and influence dynamics. The circle of influence object 404 provides detailed data on member influence and interaction patterns. The circle object 402 presents this data in a user-friendly format, offering insights for better circle management. The circle object 402 manages the structural and operational aspects of a circle, including member management, content handling, and notifications. The circle of influence 404 object focuses on influence dynamics, calculating and updating influence scores, and adjusting content visibility based on these scores. Together, they create a dynamic and engaging environment within each circle, enhancing user interactions and experiences in the social media application.

Certain embodiments of the present invention are described herein, including the best mode known to the inventors for carrying out the invention. Of course, variations on these described embodiments will become apparent to those of ordinary skill in the art upon reading the foregoing description. The inventor expects skilled artisans to employ such variations as appropriate, and the inventors intend for the present invention to be practiced otherwise than specifically described herein. Accordingly, this invention includes all modifications and equivalents of the subject matter recited in the claims appended hereto as permitted by applicable law. Moreover, any combination of the above-described embodiments in all possible variations thereof is encompassed by the invention unless otherwise indicated herein or otherwise clearly contradicted by context.

Groupings of alternative embodiments, elements, or steps of the present invention are not to be construed as limitations. Each group member may be referred to and claimed individually or in any combination with other group members disclosed herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

As utilized herein, the term “exemplary” means serving as a non-limiting example, instance, or illustration. As utilized herein, the terms “e.g.,” and “for example” set off lists of one or more non-limiting examples, instances, or illustrations. As utilized herein, circuitry is “operable” to perform a function whenever the circuitry comprises the necessary hardware and/or code (if any is necessary) to perform the function, regardless of whether performance of the function is disabled, or not enabled, by some user-configurable setting.

The terminology used herein is for the purpose of describing particular embodiments only and is not intended to be limiting of embodiments of the disclosure. As used herein, the singular forms “a”, “an” and “the” are intended to include the plural forms as well, unless the context clearly indicates otherwise. It will be further understood that the terms “comprises”, “comprising”, “includes” and/or “including”, when used herein, specify the presence of stated features, integers, steps, operations, elements, and/or components, but do not preclude the presence or addition of one or more other features, integers, steps, operations, elements, components, and/or groups thereof.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequences of actions described herein can be considered to be embodied entirely within any non-transitory form of computer readable storage medium having stored therein a corresponding set of computer instructions that upon execution would cause an associated processor to perform the functionality described herein. Thus, the various aspects of the disclosure may be embodied in a number of different forms, all of which have been contemplated to be within the scope of the claimed subject matter. In addition, for each of the embodiments described herein, the corresponding form of any such embodiments may be described herein as, for example, “logic configured to”perform the described action.

Another embodiment of the disclosure may provide a non-transitory machine and/or computer-readable storage and/or media, having stored thereon, a machine code and/or a computer program having at least one code section executable by a machine and/or a computer, thereby causing the machine and/or computer to perform the steps as described herein.

The present disclosure may also be embedded in a computer program product, which comprises all the features enabling the implementation of the methods described herein, and which when loaded in a computer system is able to carry out these methods. Computer program in the present context means any expression, in any language, code or notation, either statically or dynamically defined, of a set of instructions intended to cause a system having an information processing capability to perform a particular function either directly or after either or both of the following: a) conversion to another language, code or notation; b) reproduction in a different material form.

Further, those of skill in the art will appreciate that the various illustrative logical blocks, modules, circuits, algorithms, and/or steps described in connection with the embodiments disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The methods, sequences and/or algorithms described in connection with the embodiments disclosed herein may be embodied directly in firmware, hardware, in a software module executed by a processor, or in a combination thereof. A software module may reside in RAM memory, flash memory, ROM memory, EPROM memory, EEPROM memory, registers, hard disk, physical and/or virtual disk, a removable disk, a CD-ROM, virtualized system or device such as a virtual server or container, or any other form of storage medium known in the art. An exemplary storage medium is communicatively coupled to the processor (including logic/code executing in the processor) such that the processor can read information from, and write information to, the storage medium. In the alternative, the storage medium may be integral to the processor.

While the present disclosure has been described with reference to certain embodiments, it will be noted understood by, for example, those skilled in the art that various changes and modifications could be made and equivalents may be substituted without departing from the scope of the present disclosure as defined, for example, in the appended claims. In addition, many modifications may be made to adapt a particular situation or material to the teachings of the present disclosure without departing from its scope. The functions, steps and/or actions of the method claims in accordance with the embodiments of the disclosure described herein need not be performed in any particular order. Furthermore, although elements of the disclosure may be described or claimed in the singular, the plural is contemplated unless limitation to the singular is explicitly stated. Therefore, it is intended that the present disclosure is not limited to the particular embodiment disclosed, but that the present disclosure will include all embodiments falling within the scope of the appended claims.

What is claimed is:

1. A method to provision a unique identifier for an entity, comprising:
receiving a request from a web server;
generating, by an identifier service, an array of 16 random bytes, wherein each byte of the random bytes is filled using a secure random function;
maintaining, by the identifier service, a central counter, wherein the counter is a shared atomic long variable;
combining, by the identifier service, the random number array and the counter to form a unique value;
converting, by the identifier service, the unique value to a 16-digit string;
returning, by the identifier service, the 16-digit unique identifier to the web server;
assigning, by the web server, the unique identifier to the entity.

2. The method of claim 1, wherein assigning the unique identifier to the entity comprises:
creating, by the web server, a circle object and a circle of influence object associated with the unique identifier, wherein the circle and the circle of influence object comprises one or more attributes and functions of the entity;
creating, by the web server, a hash address of the circle object and circle of influence object, wherein the circle hash address is based on a circle identifier and the user identifier, and the circle of influence hash address is based on the circle hash address and circle of influence of identifier;
encrypting, by the web server, the hash address of the circle object and COI object using a generated public key;
transmitting, by the web server, the unique identifier, the encrypted hash addresses, and the private key back to an application of the entity.

3. The method of claim 1, wherein maintaining a central counter comprises:
accessing the counter to ensure thread safety during a counter increment operation;
ensuring the counter is maintained by the identifier service.

4. The method of claim 1, wherein combining the random number array and the counter to form a unique value comprises:
performing bitwise operations to concatenate the random bytes and the counter to form a single 56-bit value;
ensuring each byte is bitwise ANDed with 0xff to convert it from a signed byte to an unsigned byte;
left-shifting the 56-bit combined value by 8 bits and appending the lower 8 bits of the counter to the shifted value using a bitwise OR operation.

5. The method of claim 1, wherein converting the unique value to a 16-digit string comprises:
converting the unique value into a 16-digit string with leading zeroes using a StringFormat method;
applying a modulo operation with 10000000000000000L to ensure the unique value remains within the 16-digit range.

6. The method of claim 1, wherein returning the 16-digit unique identifier comprises:
calling a SecureAPI method to return the unique identifier generated;
passing the unique identifier to the web server for further processing.

7. The method of claim 1, wherein the function is configured to use the java. util. Random class for generating random numbers.

8. The method of claim 1, wherein the atomic long variable is updated within a synchronized block to prevent race conditions.

9. The method of claim 4, wherein the bitwise operations used to combine the random bytes and the counter involve:
left-shifting each byte of the random bytes array by a multiple of 8 bits;
combining the shifted bytes using a bitwise OR operation to form the 56-bit value.

10. The method of claim 5, wherein the StringFormat method is used to format the unique value into a 16-digit string with leading zeroes.

11. The method of claim 6, wherein the SecureAPI method ensures the secure transmission of the unique identifier for assigning the identifier to the entity.

12. A system to provision a unique identifier for an entity, the system comprising:
a web server configured to send a request to an identifier service for generating a unique user identifier;
the identifier service configured to:
generate a random number array of 16 random bytes, wherein each byte of the random bytes is filled using a secure random function;
maintain a central counter, wherein the counter is a shared atomic long variable;
combine the random number array and the central counter to form a unique value;
convert the unique value into a 16-digit string;
return the 16-digit unique identifier to the web server; and
wherein the web server is further configured to assign the unique identifier to the entity.

13. The system as claimed in claim 12, wherein web server is further configured to assign the unique identifier to the entity comprises:
create a circle object and a circle of influence object associated with the unique identifier, wherein the circle and the circle of influence object comprises one or more attributes and functions of the entity;
create a hash address of the circle object and circle of influence object, wherein the circle hash address is based on a circle identifier and the user identifier, and the circle of influence hash address is based on the circle hash address and circle of influence of identifier;
encrypt the hash address of the circle object and COI object using a generated public key;
transmit the unique identifier, the encrypted hash addresses, and the private key back to an application of the entity.

14. The system as claimed in claim 12, wherein the identifier services is configured to
access the counter to ensure thread safety during a counter increment operation, wherein the counter is a shared atomic long variable;
ensure the counter is maintained by the identifier service.

15. The system as claimed in claim 12, wherein the identifier services is configured to
perform bitwise operations to concatenate the random bytes and the counter to form a single 56-bit value;
ensure each byte is bitwise ANDed with 0xff to convert it from a signed byte to an unsigned byte; and
left-shift the 56-bit combined value by 8 bits and appending the lower 8 bits of the counter to the shifted value using a bitwise OR operation.

16. The system as claimed in claim 12, wherein the identifier services is configured to
convert the unique value into a 16-digit string with leading zeroes using a StringFormat method;
apply a modulo operation with 10000000000000000L to ensure the unique value remains within the 16-digit range.

17. The system as claimed in claim 12, wherein the identifier services is configured to
call a SecureAPI method to return the unique identifier generated;
pass the unique identifier to the web server for further processing.

18. The system as claimed in claim 12, wherein the function is configured to use the java.util.Random class for generating random numbers.

19. The system as claimed in claim 12, wherein the atomic long variable is updated within a synchronized block to prevent race conditions.

20. The system as claimed in claim 15, wherein the bitwise operations comprise
left-shifting each byte of the random bytes array by a multiple of 8 bits; and
combining the shifted bytes using a bitwise OR operation to form the 56-bit value.
